(19) United States
(12) Patent Application Publication
(10) Pub. No.: US 2005/0289459 A1
(43) Pub. Date: Dec. 29, 2005

(54) Learning method and system and method of conducting business

(76) Inventor: Paul Walton, Redmond, OR (US)

Correspondence Address: John P. Luther, Jenkens & Gilchrist, 225 W. Washington Street, Suite 2600, Chicago, IL, 60606, US

(21) Appl. No.: 11/101,382

(22) Filed: Apr. 6, 2005

(51) Int. Cl. G06F 15/00

(52) U.S. Cl. 715/526

(57) ABSTRACT

The present invention provides an electronically interactive educational and/or cognitive learning method and system in which electronically reproduced text and imagery may have portions thereof selected and automatically converted into notes and/or cues, annotations automatically inserted therein, dictionary definitions, thesaurus meanings, word etymology and language conversions displayed or automatically inserted therein for a learning reference or note guide with respect to the text or imagery.

### FIELD OF THE INVENTION

The present invention relates to an interactive educational and/or cognitive learning method and system in which the mental assimilation and/or learning of the subject matter of printed materials is enhanced and/or augmented by the provision of automated learning and recollection aids.

### COPYRIGHT NOTICE

Copyright notice 2005 Paul Walton. All rights reserved. A portion of the disclosure of this patent application/patent document contains material which is subject to copyright protection. The copyright owner has no objection to the facsimile reproduction by anyone of the patent document or the patent disclosure as it appears in the United States Patent Trademark Office file or records.

### BACKGROUND OF THE INVENTION

Printed educational materials in the form of printed text and graphics, such as books, magazines, newspaper articles and the like, have long been a mainstay for recording and distributing information, views, opinion, and fiction for both educational and entertainment venues, as well as other markets. In many cases, such printed textual material is available via electronic media, such as the Internet, television or videos and the like. Electronic media is highly desirable in recent times due in large part to convenience of access and use, as such materials may be conveniently carried in a handbag and viewed in any convenient outlet.

Several methods and systems have recently been reported which are said to enhance the use of electronically accessible printed material, such as forms of enhanced reading. For example, in U.S. patent application Publication No. 2003/0059758, an enhanced reading system, and method is described which provides a printed book with associated electronic media, or an interactive two-directional system combining a printed book and electronic media capable of fully engaging a user reader. The system is operated by electronic data stored on a remote database, and with individual portions of the interactive electronic data corresponding to portions of the printed book, such as supplemental text, images, sounds, multimedia and/or multimedia animation, all of which is said to provide for a more engaging reading experience. Additionally, printed books are provided with emblems which indicate the location of interactive electronic data and visual cues are dispersed throughout the book which corresponds to specific portions of the interactive electronic data. The specific portions relate to the printed material in the proximity of the visual cues. With the use of a computer, a reader may actuate an emblem and visual cue to access individual portions of the interactive electronic data via an interface, after which the reader may return to reading further portions of the book. There is also provided a return point feature by which the interface-supplied electronic data instructs or enables the reader to resume reading the printed material at a specific point in the text as desired.

U.S. Pat. No. 6,549,750 describes a similar arrangement in a system and method for augmenting a printed text with electronically stored data in the form of images, sounds and/or supplemental text. Here, data associated with supplied reading text is again stored in a remotely accessible electronic data server and which is accessible via the reader's computer by way of a graphical user interface. The stored data may be a glossary of words which appear in the printed text. In operation, reading text is imprinted with graphic indicia, such as a symbol or icon, on one or more pages to provide a visual cue associated with electronically stored data available for retrieval by the reader. The indicia may also visually relate to the immediate textual subject matter. Stored image data may be in the form of maps or photographs of subject matter referred to in the text, or other illustrations, and sound data may comprise textual narrations, such as mood setting music such as used in motion pictures. The supplemental text may be sidebars which relate to the text, alternative accounts of textually described events or unabridged accounts of condensed text, such as an electronically stored running synopsis to which a reader may be prompted to access at various points throughout the printed material without reading any information beyond such point. Access may be through the graphic indicia prompt, or by entry of a printed text page number following an appropriate prompt.

In U.S. Pat. No. 6,269,238 there is described yet another variation of printed textual reading material which is associated with electronically stored data in a remote server for retrieval in the form of images, sounds and/or supplemental text, and which again are accessible through prompts or visual cues in the form of graphic indicia on a computer screen by way of a graphical user interface. In this rendition, a graphical user interface displays second graphic indicia which is visually correlated with the first graphic indicia such that a reader/user may unambiguously identify a symbol or icon on the computer screen which corresponds to a symbol or icon appearing in the reading text.

Additionally, U.S. Pat. No. 5, 957,697 discloses still another method and system for augmenting the reading of printed text with electronically stored data in the form of images, sounds and supplemental text by way of an electronic virtual book which emulates the appearance of a printed book and which may be accessed with a password contained in the printed book. The text of the book is augmented by such electronically stored data and information linked to the virtual book including, for example, vocalization of the text of the book.

Still other described methods employing such associated electronic content with virtual reading material are disclosed in U.S. Pat. Nos. 5,597,307; 5,624,265 and 5,9554,515.

What is lacking in conventional methodology, however, is the ability for readers/users to formulate their own custom notes or cues, or to record those of others, in an interactive fashion with printed material for a personalized understanding and remembrance of printed material, and to use such custom notes and/or cues to refer to printed material as desired. It would therefore be highly beneficial to provide such capability.

### SUMMARY OF THE INVENTION

In order to fulfill long deficient needs such as described above, the present invention provides a learning and/or reference method and system comprising displaying readable text and/or images in an electronic medium, such as by way of a CD or the Internet, and then actuating an electronic highlighting feature effective to highlight one or more words, phrases, symbols, images and/or any portion of said text or image on demand or as desired, and further wherein the highlighting feature is effective to store such selected or referenced subject matter in the form of custom-made personalized notes or cues for future reference or retrieval, preferably by way of a computer code feature.

In a further embodiment the inventive method and system provides for electronic interactive access of such stored subject matter with associated portions of said readable text or images to which it refers.

In yet a further embodiment, the present invention provides for the recordation of customized notes and/or cues directly into electronic readable text or images, whether drafted by a user thereof or the recordation of another's remarks, such as those of an instructor, teacher or narrator, for the custom fabrication of personalized annotated reading material imagery.

In still yet another embodiment of the invention, there is provided a method and process for use with any of the above-described features, or with any conventional reading enhancement method, in which a reader/user of electronically reproduced written material or imagery may at any time ascertain the definition, thesaurus meaning, proper usage or etymology of any word, phase, symbol or image.

Additionally, there is also provided a search feature for use with electronically displayed textual material or imagery in which a user may conduct a search throughout a document or presentation for a particular word, phrase, symbol, graphical display or whatever is desired, with the search feature displaying or recording where search items are located throughout the material or imagery, or portions thereof, and wherein said search materials are optionally associated with location coordinates within the material or imagery for reference where such items of interest are located

The invention is more fully understood with reference to the following Detailed Discussion of Preferred Embodiments with accompanying drawings.

### BRIEF DISCUSSION OF THE DRAWINGS

FIG. 1 is an illustration depicting an embodiment of a learning method and system in accordance with the present invention displaying a computer generated interactive readable text and graphics with icons or symbols which can be actuated for enabling features of the present invention.

FIG. 2 is an illustration depicting a page or a portion thereof of interactive electronic readable text with portions highlighted or otherwise signaled out to create stored custom made notes or cues in accordance with the present invention.

FIG. 3 is an illustration of another embodiment of the invention depicting the interaction of a user/reader with electronic readable text creating custom annotated notes by the addition to said text of personalized notes and/or remarks and/or those of a narrator.

FIG. 4 is an illustration of a flow chart diagram depicting another embodiment of the present invention.

FIG. 5 is an illustration of a schematic diagram depicting yet another embodiment of the invention.

### DETAILED DISCUSSION OF PREFERRED EMBODIMENTS

All patent references, published patent applications and literature references referred to or cited herein are expressly incorporated by reference to the same extent as if each were specifically and individually indicated to be incorporated by reference. Any inconsistency between these publications and the present disclosure is intended to and shall be resolved in favor of the present disclosure.

In the following discussion, many specific details are provided to set forth a thorough understanding of the present invention. It will be obvious, however, to those skilled in the art that the present invention may be practiced without specific details, and in some instances of this discussion with reference to the drawings known elements have not been illustrated in order not to obscure the present invention in unnecessary detail. Such details concerning computer networking, software programming, telecommunications, and the like have not been specifically illustrated as such are not considered necessary to obtain a complete understanding of the core present invention, but are considered present nevertheless as such are considered to be within the skills of persons of ordinary skill in the art.

It is also noted that, unless indicated otherwise, all functions described herein may be performed in either hardware or software, or some combination thereof. In some preferred embodiments the functions are performed by a processor such as a computer or an electronic data processor in accordance with code, such as a computer program code, software, and/or integrated circuits that are coded to perform such functions.

Additionally, the processing that is depicted in the drawings and described below is generally depicted as hierarchical structure for readability and understandability. Various other methodologies, such as object-oriented techniques, are preferred for the physical embodiments of the invention in order to maximize the use of existing programming technique. One of ordinary skill in the art will appreciate that that the techniques described herein may be embodied in many different forms.

For illustrative purposes only, the following discussion illustrates and discusses the present invention in reference to various embodiments which may perhaps be best utilized subject to the desires and subjective preferences of various users. One of ordinary skill in the art will, however, appreciate that the present invention may be utilized to enhance the reference capacities, cognitive learning skills, and enhanced learning and appreciation in general.

Having thus prefaced this discussion, one major advantage of the present invention, of which there are several, is the enhanced learning ability it affords through its similarity to a cognitive learning approach, as opposed to a much less efficient and problem prone approach of rote memorization procedures. Cognition refers to mental activity which includes thinking, remembering, learning, and using language, among other things. It has also been described as an active recursive, integrated process in which information is modified to reconstruct what one knows. As opposed to rote memorization, a cognitive approach to learning and teaching, or otherwise understanding the content of a textual document and/or image, focuses on the understanding of information and concepts. The ability to understand the connection between concepts and to process information by rebuilding it with logical connections, such as summarizing in one's own words, is well known to increase the retention and understanding of material. Such an approach is not only useful in the classroom, but finds important application throughout society, such as in the digestion and understanding of voluminous business and financial reports, SEC filings, depositions, and transactional and scientific documents and reports to name only a few.

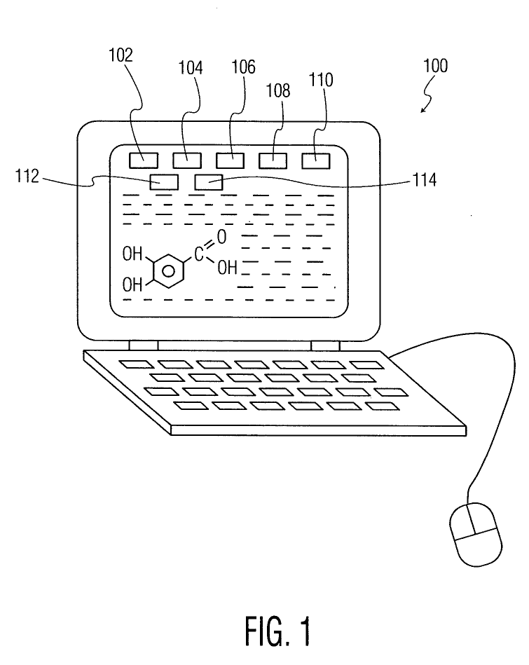

In one aspect the present invention employs a cognitive approach to learning and understanding by enabling a user to construct their own custom-made notes and cues by interacting with virtual text and/or images reproduced in electronic media, and using such stored electronic notes to refer to portions of text or imagery from which it relates or from which such were constructed. More specifically, referring now to FIG. 1 there is depicted in this illustration readable text and graphics (chemical formulae), such as a page from a book, which is reproduced in virtual electronic form, for example, by way of a CD or an Internet web page. In some preferred embodiments, readable textual material may be, without limitation, an electronically reproduced printed book with a plurality of pages, or a financial report company filing such as an SEC report, or a scientific publication. Also contemplated, for example, are instructional use manuals, personal narratives, and manuscripts for plays and movies, and legal briefs, pleadings and depositions, pictures, graphs, charts or other types of printed material, any and all which do not easily lend themselves to rote memorization. Virtual readable material or images may be reproduced on a computer screen, for example, by means of a CD or other electronic storage medium, or may be viewed on an Internet web site, electronic journal, or PDA, or a mobile phone device by way of Short Messaging Service (“SMS”) text messaging or Multimedia Messaging Service (“MMS”) multimedia messaging capable of text, graphics, images, and animation accessing a Web site, or any other type of electronic device capable of displaying text and/or graphics. There may be images in addition to text, or symbols, graphs, graphics, spreadsheets, pictures, animations, chemical formulae, mathematical analysis and equations, computer code, electronic circuitry or various combinations thereof, or any other type of electronically displayed visual image possible.

Further shown in the sample embodiment of FIG. 1 is an electronic display produced by way of computer code of the invention 100 with one or more icons, or other symbols which may be actuated by a user, for example, by pointing to and clicking with a mouse device, to enable one or more features of the invention, such as note taking by highlighting words, phrases, symbols, images, graphics and the like in textual, imagery on graphical material and actuating a note taking icon 102 to automatically produce a retrievable compilation of personalized notes and/or cues, optionally complete with their location coordinates in the subject matter from which they came for a convenient back or cross-reference. Other features may be actuated by way of a search icon 104, a dictionary definition icon 106, a thesaurus icon 108, a trash icon 110, a personalized annotation icon (the user's own notes or comments) 112, a lecture note or annotation icon (notes, comments or remarks from other than the user) 114 (or several of these for different lecturers or commentators), an etymology icon 116, a proper word or phrase usage icon 118, and one or more language conversion icons 118. As will be appreciated by way of the present invention a user will be automatically enabled to compose custom-made annotations with notes and/or cues of her own or those of others by pointing to a position in the material or imagery and then typing in an annotation, and then simply actuating a personalized annotation icon or a lecture note annotation icon, which may produce annotations in different colors, depending upon the originator of the remarks, or different fonts, bold, etc., optionally in one or more languages as desired, for the automatic fabrication of a highly detailed set of annotations.

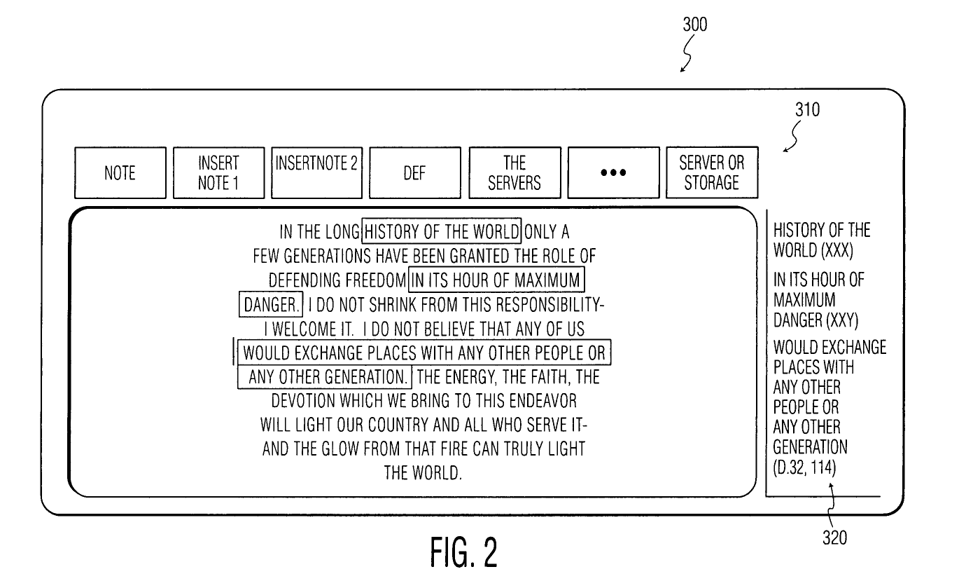

As shown in the illustrative embodiment of FIG. 2 the textual or image display is interactive, in that a user or reader may use a browser running on a computer to actuate an icon or otherwise enable a highlighting feature which is effective to highlight 200, such as by a “click and drag” activity, or otherwise single out or select any words, phrases or symbols of the readable textual material or of any portion of an image as desired by the use of a cursor and mouse device. Once highlighted and, for example, the note taking icon actuated, the selected words, phrases or images and the like are automatically stored 210 locally or, for example, are stored on a remote server in retrievable form which enables the reader/user to compose a custom-made set of notes and cues with respect to the subject matter personalized to the user. The term “highlighting” is used herein merely for illustrative purposes, and any equivalent form indicative of selected subject matter for custom-made note or cue making is contemplated herein, such as boldface or italics, different fonts, colors, or in some embodiments nothing at all, as the personalized notes and/or cues are made automatically and portions of the subject matter from where they are made may be referred to automatically in accordance with another feature of the invention as discussed more fully below. Highlighted words, phrases, symbols, graphics, images, pictures and the like will preferably be stored along with their particular reference coordinates 220, shown generally as “XXX” or “XXY”, from where such came, such as “Page 32, para. 4, lines n-nn, or any conventional format such as prescribed by the Modern Language Association (MLA), which may be selected by the user. If none are selected a default set of reference coordinates, such as page, paragraph and line number may be employed.

It is further contemplated that, for example, should material be viewed and notes and/or cues and annotations and the like fabricated by way of a CD, suitable security functions are installed on the CD to prevent unauthorized reproduction and/or use. In some contemplated embodiments access to such a CD may be purchased for a period of time along with a book or other text or imagery or in place thereof.

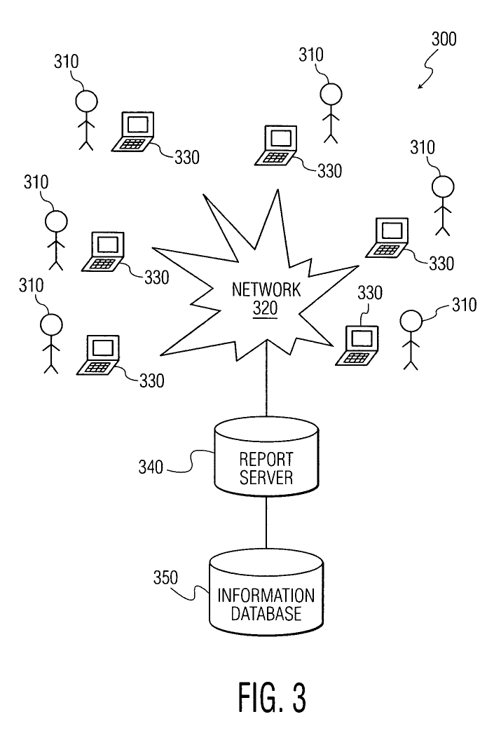

An additional embodiment of the operation of the invention is further illustrated in FIG. 3 of the drawings in which a variety of users may take advantage of the present invention by viewing electronically displayed subject matter, downloading or actuating a computer code of the invention and fabricating retrievable custom-made notes, cues and annotations therefrom. Here, the reference numeral 300 generally denotes a system which embodies features of the present invention, and which generally comprises users 310 accessing a network 320, such as the Internet, a local-area network (LAN), wide-area network (WAN), and the like, via an access device 330, such as a workstation (laptop), cell phone, personnel data assistant (PAD), and the like. Preferably the access device 330 is configured to provide a text and image display on which the user 310 may view information subject matter. The access device 330 is also configured to receive information from and to transmit information to a network 320, and may be connected to the network 320 by way of any known technology, such as by wireline, wireless via a WAP site, fiber optics and the like. A report server 340 is configured to connect to the network 320 to transmit information to and to receive information from the network 320. The report server 340 may comprise, for example, a standard Web server designed to connect to the Internet and to receive and to provide information to a plurality of remotely connected users 310 via the Internet. The report server 340 may also comprise a plurality of servers networked together to access a large number of users 310. The report server 340 is also preferably configured to access an information database 350, which may be a standalone database server providing for a large storage capacity by way of any known technology such as wireline, wireless, fiber optics and the like. In operation, the information database 350 comprises a relational database which allows storage of custom-made notes or cues, or annotations, in accordance with the invention, or a query written in standard SQL to extract information on demand, such as the location of subject matter of custom-made notes or cues in material from which such was produced, the dictionary definition or thesaurus meeting or etymology of a word or phrase, and language translations and conversions and the like in accordance with the invention. Some examples of informational databases include, for example, Informix, Sybase, and Oracle. Extraction of information from relational databases and the generation of reports may be accomplished by any commercially available method, such as with the use of CrystaReports or BusinessObjects, or note/cue sheets with annotations generated by a Word or WordPerfect program. In additionally preferred embodiments, there is employed a connection between the access device 330 and the report server 340 which by way of the network 320 is configured to employ secure transmission technology to prevent unauthorized access to the network 320 and from intercepting and viewing personalized custom-made notes, cues and annotations in accordance with the invention. The report server 340 is also preferably configured to prevent unauthorized access thereto.

Contemplated herein are any conventional type of database for storage and retrieval of personalized notes, cues and/or annotations made in accordance with the invention which, for example, may be stored and accessed via a Word or WordPerfect program or a network using any of a personal computer, mainframe computer, PDA, phone device or essentially any device capable of transmitting, receiving and displaying information. For example, in some instances an interface such as Web page may be employed to display and store personalized data on a remote server/database. The interface may be developed using conventional programming techniques which are well known in the art. In an example of operation a main interface may be accessed via the Internet by inserting a web address into an address field of a conventional browser running on the computer. Stored and retrievable material may, of course, be in any language as desired, or may be stored in one language and automatically converted to another, or stored at the first instance in any language or form desired, or converted to any language at will, thereby enabling a person to custom make notes from, say, a French document and have the notes retrievably stored in English. This feature may be implemented by using conventional programming techniques.

In a further embodiment of the inventive method and system, stored custom-made notes and cues may be used interactively (“interactive data”) with textual or imagery material from which it relates by an inventive feature which automatically returns to the portion of text or imagery from which it was made, or to any return point as desired. Thus a reader/user may in accordance with the invention reference at will portions of text or imagery referring to their custom-made notes, for example, as reinforced learning in school or as a quick reference guide, such as in a courtroom or legal setting or in a business meeting where total recall is not possible, but where accurate and quick referencing is perhaps pivotal. Again, to implement this return point feature conventional programming techniques may be employed.

In yet a further embodiment of the invention there is provided an optional feature for the recordation of customized notes, cues or remarks directly into electronic readable text or imagery. The notes/and or cues may be those of the user/reader or of another, such as a teacher's notes or those of a lecturer or of a narrator, notations as to a dictionary meaning, thesaurus meaning or a word etymology, or words automatically converted to any language as desired, for the production of custom-made annotated reading material or imagery. Electronically inserted notes, cues or otherwise “annotations” may be conveniently italicized, boldfaced, differently colored (depending upon whether they are the reader's or narrators) or bracketed in some form to indicate their status as annotations and from what source they came from. This feature may be employed by way of any conventional programming techniques, and may be used as a stand alone feature or in conjunction with the inventive features discussed above.

In yet an additional feature of the method and system of the present invention there is provided immediate electronic access by the user/reader to a definition, dictionary meaning, etymology, thesaurus meaning, description and/or explanation of proper use of any word, symbol, phrase, image, or graphics and the like, or any language conversion, in a readable text or image by electronically singling same, such as by highlighting or actuating an icon or feature. This feature may be served by way of a separate database and actuated by a feature or icon displayed by an interface for use at will. Chemical reactions and synthetic routes, mathematical equations such as algebraic, trigonometric and calculus manipulations, and graphing of functions, such as marketing, economic and statistical analysis and relationships are also contemplated for insertion into a note or cue field.

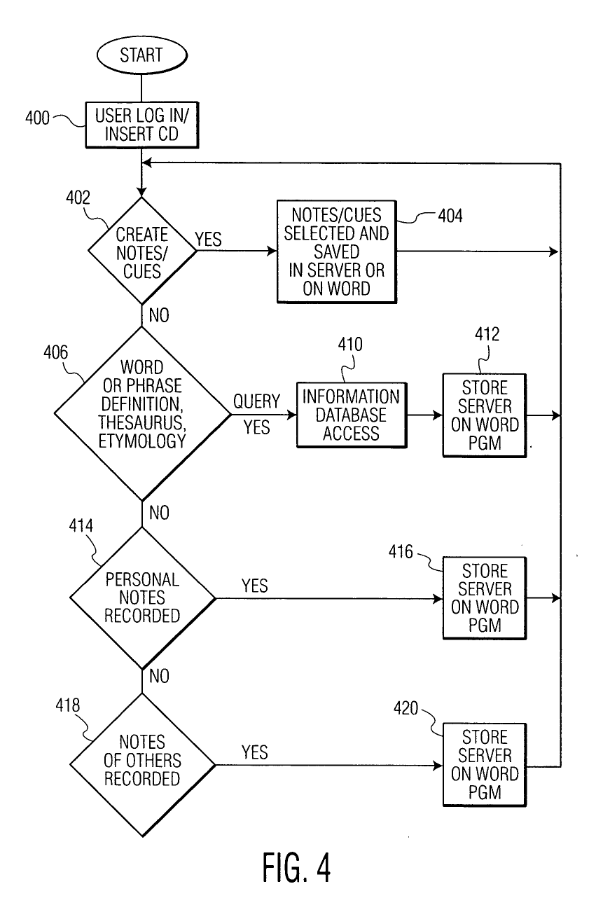

FIG. 4 is a data flow diagram which illustrates steps which may be performed by the report server 340 shown in FIG. 3 in accordance with embodiments of the invention A user 400 will log into the inventive system or, for example, insert a CD of the invention which embodies a text or reading material of some sort, a financial report, or a scientific journal, or a presentation with text, imagery and graphics, and the inventive computer code. Upon viewing the electronic display, the user will be enabled to highlight various words, phrases, graphics and/or imagery to create cues and or notes 402 which will be automatically stored in a server, or in a Word or WordPerfect document, for later retrieval and use. If so desired, a definition of a word or phrase, thesaurus meaning, etymology or foreign language translation or conversion may be queried 406, or other items and/or information queried as described above, for example, by way of information database 410 and stored with said custom-made notes in the order that they are made by the user. Personalized annotations 414 are also made and stored 416, or those from other's are entered 418 and stored 420 for the automated production off an all-in-one study or reference material complete with notes, cues, annotations, dictionary definitions, thesaurus meanings, word usage, etymology and foreign language translations/conversions, chemical reaction products, mathematical solutions, equations, marketing, business and statistical analysis etc.

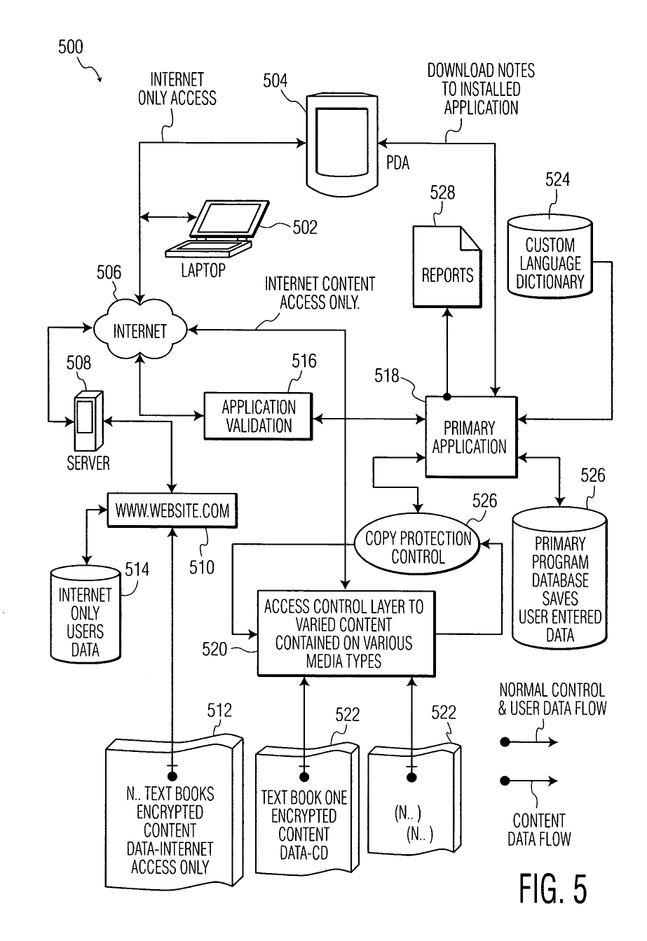

As additionally shown in FIG. 5, there is illustrated an example of a network system for operation of various embodiments of the inventive learning method and system. In this system, generally referred to as 500, operational terminals, such as a personal computer or laptop 502, or PDA 504, are accessed through an Internet connection 506 by way of an ISP server 508. Here, web site www.website.com 510 containing access to electronically produced text, images and graphics and the like 512 for data Internet access and an Internet user's database 514 are accessed for use with application validation 516, such as login, with a primary application 518. An access control layer 520 allows access to encrypted content data on a CD 522 to primary application 518. As also shown in this embodiment, a copy protection control security device 526 is installed to prevent unauthorized copying or access. A user when viewing content may then fabricate custom-made notes and cues by highlighting portions thereof and/or actuating and/or downloaded to primary application 518, or access custom language dictionary 524 for word/phrase definition, usage, etymology etc., and primary program database 526 will save user entered data for creation of notes, cues and/or annotated text or imagery as shown in reports 528.

In other aspects of the invention, the inventive method and system and its manufacture and installation provide for heretofore unavailable advantages in conducting a wide array of business functions, including designing activities, manufacture, use, marketing, sales, leasing and licensing of such products. Other advantages afforded by their inventive products are their use in generating business goodwill, in the generation of valuable trademark rights as source identifiers, and as novel and unique material and subject matter for the formation and operation of new business entities, various joint venture endeavors and collaborations.

The invention has been described in conjunction with illustrative examples of some preferred embodiments, but it is not to be construed to be so limited as one skilled in the art will be able to utilize and employ substitute and equivalents thereof without departing from the scope and bounds of the invention and the spirit thereof.

1. A learning and/or referencing method comprising displaying readable text or imagery presented in an electronic medium and then actuating an electronic highlighting feature and highlighting one or more words, symbols, phrases, graphics or any portion of said readable text or imagery, wherein said highlighting feature is effective to retrievably store said highlighted item or items for future reference.

2. The method of claim 1 wherein said readable text comprises a page or a book of a plurality of book pages.

3. The method of claim 1 wherein said readable text or imagery comprises a page or a plurality of pages of a report, presentation, play, script or any document.

4. The method of claim 1 wherein said readable text comprises a page or a plurality of pages a deposition.

5. The method of claim 1 wherein said highlighting feature is further effective to determine and retrievably store the coordinates of said highlighted item or items for reference to the original readable text of image where such items may be found.

6. The method of claim 1 wherein said method is further effective to electronically insert into readable text or imagery remarks and/or annotations which may be differentiated by italics, color, font, brackets, bolding and underlining.

7. The method of claim 1 wherein said method is further effective to display or insert into text or imagery a dictionary definition, a thesaurus meaning, word etymology, foreign language conversions of words and phrases, chemical reactions, mathematical analysis, economic, business, statistical and marketing analysis graphs.

8. A computer program product for a learning and/or referencing method, the computer program product comprising computer program code for determining a set of information comprising user selected words, phrases, symbols, graphics or images or any portion of an electronically displayed readable text or imagery, computer program code for transmitting said selected information to a receiver means and computer program code for receiving and retrievably storing said selected information.

9. The computer program of claim 8 wherein the computer program code for determining a set of information is also effective to determine the coordinates of said selected with respect to portions of information selected from said electronically displayed text or imagery.

10. The computer program product of claim 8 wherein the program code for determining a set of information is further effective to electronically insert into readable text or imagery remarks or annotations which may be differentiated as to source by color, font, italics, bolding, and underlining.

11. The computer program product of claim 8 wherein said program code is further effective to display or insert into text or imagery a dictionary definition, a thesaurus meaning, word etymology, foreign language conversions of words and phrases, chemical reactions and syntheses, mathematical analysis and equations, business, economic, statistical and marketing analysis graphical displays.

12. The computer program product of any of claims 8, 9, 10 and 11 in which text or images and said computer program code are contained in a CD.

13. A system comprising the computer program product of claim 8.

14. A system comprising the computer program product of claim 9.

15. A system comprising the computer program product of claim 10.

16. A system comprising the computer program product of claim 11.

17. A method of conducting business functions comprising the method of claim 1.

18. A method of conducting business functions comprising the computer program product of claim 8.

19. A method of conducting business functions comprising the system of any of claims 13, 14, 15, and 16.
